(19) United States
(12) Patent Application Publication
(10) Pub. No.: US 2019/0102321 A1
(43) Pub. Date: Apr. 4, 2019

(54) TECHNIQUES TO PROVIDE ACCESS PROTECTION TO SHARED VIRTUAL MEMORY

(71) Applicant: INTEL CORPORATION, SANTA CLARA, CA (US)

(72) Inventor: ANNA TRIKALINOU, Hillsboro, OR (US)

(21) Appl. No.: 15/719,977

(22) Filed: Sep. 29, 2017

(51) Int. Cl. G06F 12/14; G06F 12/1027; G06F 12/1009

(52) U.S. Cl. CPC G06F 12/145; G06F 12/1027; G06F 2212/1052; G06F 2212/65; G06F 2212/68; G06F 12/1009

(57) ABSTRACT

Various embodiments are generally directed to techniques for shared virtual memory (SVM) access protection, such as by performing a security check whenever a write request arrives from an SVM device, for instance. Some embodiments are particularly directed to an input/output memory management unit (IOMMU) that prevents an SVM device from modifying a code page with a memory transaction request by generating an access request fault and/or a translation completion with read-only access in response to the memory transaction request.

### BACKGROUND

Shared memory may refer to memory that can be simultaneously accessed by multiple programs or processes with an intent to provide communication among them or avoid redundant copies. Virtual memory may refer to a memory management technique that maps memory addresses used by a program or process, called virtual addresses, to physical addresses in computer memory. In various embodiments, translation to/from a virtual address from/to a physical address may occur transparently to the program or process. Typically, an operating system (OS) may manage the virtual address spaces and the assignment of physical memory to virtual memory.

### BRIEF DESCRIPTION OF THE DRAWINGS

FIG. 1 illustrates an embodiment of a first operating environment.

FIG. 2A illustrates an embodiment of a second operating environment.

FIG. 2B illustrates an embodiment of a third operating environment.

FIG. 3 illustrates an embodiment of a fourth operating environment.

FIG. 4 illustrates an embodiment of a fifth operating environment.

FIG. 5A illustrates an embodiment of a first logic flow.

FIG. 5B illustrates an embodiment of a second logic flow.

FIG. 6A illustrates an embodiment of a third logic flow.

FIG. 6B illustrates an embodiment of a fourth logic flow.

FIG. 7 illustrates an embodiment of a storage medium.

FIG. 8 illustrates an embodiment of a computing architecture.

FIG. 9 illustrates an embodiment of a communications architecture.

### DETAILED DESCRIPTION

Various embodiments are generally directed to techniques for shared virtual memory (SVM) access protection, such as by performing a security check whenever a write request arrives from an SVM device, for instance. Some embodiments are particularly directed to an input/output memory management unit (IOMMU) that prevents an SVM device from modifying a code page with a memory transaction request by generating an access request fault and/or a translation completion with read-only access in response to the memory transaction request. In various embodiments, the memory transaction requests may include one or more of memory access requests and memory translation requests. In one embodiment, for example, an apparatus for memory access protection may comprise a memory and logic for an IOMMU, at least a portion of the logic implemented in circuitry coupled to the memory. In various embodiments, the logic may receive a memory access request, identify a cached translation entry associated with an address included in the memory access request, and determine whether to perform the memory access request based on a type of the memory transaction request and a permission set included in the cached translation entry. In some embodiments, the logic may receive a memory translation request and determine whether to generate a translation completion with read and write access or read-only access based on whether a memory page associated with the translation request is executable. These and other embodiments are described and claimed.

Some challenges facing IOMMUs include the inability to perform a security check to prevent an SVM device from modifying a code page. These challenges may result from an SVM device having implicit access to the entire process memory space. In some situations, these challenges may provide an attack vector for a malicious user. For instance, a malicious user may manipulate a workload of an SVM device to corrupt a central processing unit's (CPU's) process memory and hijack its control flow. Adding further complexity, many applications can choose the read, write, and execute permissions of their own memory pages. For instance, sometimes both write and execute permissions may be granted simultaneously, such as with Just-In-Time (JIT) code, packers, self-modifying code, and the kernel. These and other factors may result in an IOMMU with poor security and limited functionality. Such limitations can drastically reduce the usability and applicability of the IOMMU, contributing to ineffective systems with security vulnerabilities and limited capabilities.

Various embodiments described herein include an IOMMU that can prevent a SVM device, such as a hardware accelerator (e.g., graphics processing unit (GPU)), from modifying the code page of a CPU by performing one or more security checks. In one or more embodiments, the security checks may operate to restrict write accesses originating from an SVM device towards a CPU's code page. This and other features described herein can prevent an SVM device from being used to attack and manipulate the CPU's behavior. For example, in some embodiments, the IOMMU may perform a security check so that whenever a write request arrives from an SVM device, if the page requested is present and is executable, an access violation fault is generated and the request is terminated. In another example, the IOMMU may perform a security check so that whenever a memory translation request corresponding to a write operation arrives from an SVM device, if a memory page associated with the translation request is executable, a translation completion with read-only access is generated. This may prevent a malicious or vulnerable device from corrupting the CPU's process memory and causing an arbitrary code execution with the CPU process's privileges. Additionally, in various embodiments, efficiencies may be realized by performing the security checks based on one or more bits in cache entries, such as in a translation lookaside buffer (TLB) cache. In various such embodiments, this may prevent overhead such as additional page walks.

In these and other ways the IOMMU may enable reliable and efficient security checks to achieve improved shared virtual memory access protection from SVM devices while reducing attack vectors for malicious users, resulting in several technical effects and advantages.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

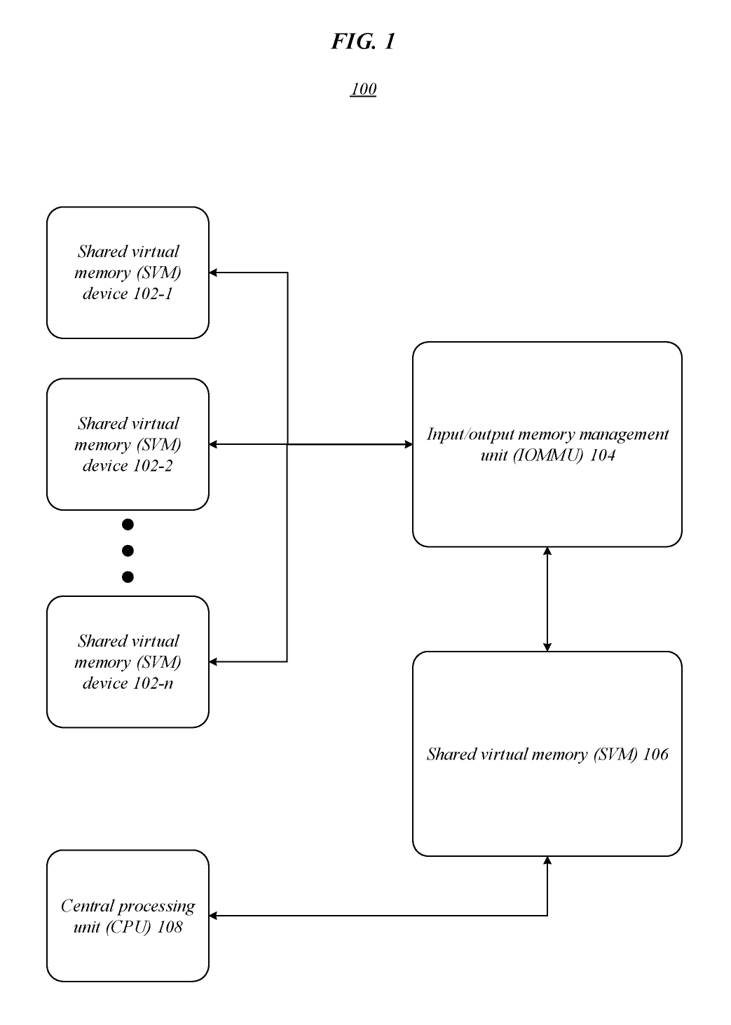

FIG. 1 illustrates an example of an operating environment 100 that may be representative of various embodiments. Operating environment 100 may include shared virtual memory (SVM) devices 102-1, 102-2, 102-n, input/output memory management unit (IOMMU) 104, shared virtual memory (SVM) 106, and CPU 108. In operating environment 100, IOMMU 104 may support memory operations between SVM devices 102-1, 102-2, 102-n and SVM 106. For example, IOMMU 104 may restrict write accesses originating from an SVM device (e.g., SVM device 102-1, 102-2, or 102-n) towards a CPU's code page (e.g., CPU 108), so that the SVM device cannot be used to attack and manipulate the CPU's behavior. The embodiments are not limited in this context.

In various embodiments, IOMMU 104 may facilitate and control memory operations between SVM devices 102-1, 102-2, 102-n and SVM 106. In various such embodiments, IOMMU 104 may be a memory management unit that connects a direct memory access (DMA) capable input/output (I/O) bus to the main memory. In one or more embodiments, SVM devices 102 may issue memory transaction requests to IOMMU 104. In one or more such embodiments, the memory transaction requests may include one or more of memory access requests and memory translation requests. In various embodiments, memory access requests may include read and/or write operations. In many embodiments, memory translation requests may include conversion of a memory address between various mappings (e.g., virtual, linear, physical, etc.). In many such embodiments, memory translation requests may utilize the address translation service (ATS) protocol. In some embodiments, main memory may be any memory that is directly accessible by CPU 108. For instance, main memory may comprise random access memory (RAM). In various embodiments, main memory may be communicatively coupled with CPU 108 via a memory bus. In various such embodiments, IOMMU 104 may receive a memory transaction request before the memory transaction request passes through the memory bus. In other such embodiments, IOMMU 104 may receive a memory transaction request after the memory transaction request passes through the memory bus. In a same or similar manner, IOMMU 104 may receive a memory transaction request from an SVM device

In one or more embodiments, operating environment 100 may include a set of one or more IOMMUs. For instance, SVM device 102-1 may have a dedicated IOMMU while SVM devices 102-2, 102-n share a second IOMMU. Various embodiments described herein may include one or more IOMMUs that perform security checks internally. In various such embodiments, the security checks may be implemented in dedicated hardware and/or circuitry. In one or more embodiments, CPU 108 may have or utilize a MMU. In some embodiments, the security checks may be performed without modifying any existing control flows (e.g., of CPU 108). In various embodiments, the security checks may be performed without additional page walks. In one or more embodiments, the capabilities may enable a global and high-impact fix for security vulnerabilities with minimal hardware changes.

In some embodiments, IOMMU 104 may enable a process of CPU 108 to directly share resources of SVM 106 with a one or more SVM devices (e.g., SVM device 102-1, 102-2, 102-n). From the software application's perspective, this may allow for seamless pointer-based data structure sharing, while from the system's perspective, it may allow for process memory page table sharing and device page faulting. However, by using SVM 106, the SVM device may have implicit access to an entire 64-bit process memory, and without IOMMU 104 performing a security check to restrict write accesses originating from an SVM device towards a CPU's code page, the SVM device may be used as a means to attack and manipulate the CPU's behavior.

Accordingly, in one or more embodiments described herein, IOMMU 104 may perform a security check to determine whether or how to perform a memory transaction request (e.g., memory translation request and/or memory access request) based on one or more attributes of the request, such as source or type, and an associated permission set. For instance, determination of whether to perform a memory transaction request may be based on one or more of whether a source of a memory transaction request is an SVM device, whether the memory transaction request is a memory translation request, whether the memory transaction request includes or is associated with a write request, whether an associated permission set allows or restricts the memory transaction request, whether a memory page associated with the memory transaction request is present in main memory, and whether the memory page associated with the memory transaction request is executable. In some embodiments, the associated permission set may be included in a translation entry stored in a cache.

In some embodiments, when IOMMU 104 receives a memory transaction request for SVM 106, it may determine whether the source of the memory transaction request is an SVM device (e.g., SVM device 102-1, 102-2, or 102-n). In some such embodiments, when IOMMU 104 determines a memory transaction request was received from an SVM device, it may determine whether the memory transaction request is a write request. However, if the memory transaction request is not from an SVM device and/or is not a write request, IOMMU 104 may serve the memory transaction request by communicating data from/to SVM 106 to/from the source of the memory transaction request. For instance, when a memory transaction request comprising a read request is received from SVM device 102-2, IOMMU 104 may serve the read request by communicating data from SVM 106 to SVM device 102-2.

In various embodiments, when IOMMU 104 receives a memory transaction request from an SVM device that includes a write request, IOMMU 104 may identify a memory page in SVM 106 associated with the write request and determine whether the associated memory page is present and executable. In various such embodiments, when the memory page associated with the write request is present and executable, IOMMU 104 may generate an access violation fault, and the request may be terminated. However, if the memory page associated with the write request is not present and/or executable, IOMMU 104 may serve the write request. For example, when a write request is associated with a memory page in SVM 106 that is not executable, IOMMU 104 may serve the write request by communicating data from the requesting SVM device (e.g., SVM device 102-1, 102-2, or 102-n) to SVM 106 for storage.

In some embodiments, IOMMU 104 may map device-visible virtual addresses to physical addresses according to a paging architecture. In some such embodiments, IOMMU 104 may utilize one or more of a memory transaction request, a cache entry, a page table, a page directory, or a page-directory-pointer table supported by the paging architecture to translate a device-visible virtual address to a physical address, identify a memory page associated with a memory transaction request, determine whether the memory page associated with the memory transaction request is present in main memory, and/or determine whether the memory page associated with the memory transaction request is executable. For instance, SVM device 102-1 may send a memory transaction request to IOMMU 104 that includes a device-visible virtual address. IOMMU 104 may then identify or determine, based on the virtual address, one or more of a cache entry, a page-directory pointer, a page directory entry, a page table entry, a memory page, and a physical address associated with the memory transaction request.

In various embodiments, the paging architecture may support one or more informational bits in one or more of the cache entries, the page directory entries, the page table entries, the memory page, the physical addresses, or elsewhere. In various such embodiments, the informational bits may be used by IOMMU 104 to determine one or more characteristics or attributes of the memory transaction request, such as whether the memory page associated with the memory transaction request is one or more of present, readable, writable, or executable. For instance, a page table entry associated with a memory transaction request may include informational bits used by IOMMU 104 to determine whether the memory page associated with a memory transaction request is present and whether the memory page associated with the memory transaction request is executable. In one or more embodiments, the paging architecture may support physical address extension (PAE).

In some embodiments, a paging architecture may be used that supports an informational bit to indicate whether a memory page is present in main memory. In some such embodiments, this informational bit may be referred to as a present bit. In various embodiments, IOMMU 104 may determine whether a memory page associated with a memory transaction request is present in main memory based on the present bit. For example, a memory page associated with a memory transaction request may be present in main memory if the present bit is 1 and not present in main memory if the present bit is 0. In various embodiments, the present bit may be a PAE bit. In some embodiments, a present bit may be part of each page table entry. In some such embodiments, the present bit may be the least significant bit of each page table entry.

In various embodiments, a paging architecture may be used that supports an informational bit to indicate whether a memory page is executable. In various such embodiments, this informational bit may be referred to as an execution bit. In some embodiments, the execution bit may segregate areas of memory for use as either storage of processor instructions (e.g., executable code) or for storage of data. In other words, the execution bit may define whether the associated memory page can be used by a CPU (e.g., CPU 108) to execute code from. In various embodiments, the execution bit may be used by IOMMU 104 to determine whether a memory page associated with a memory transaction request is executable (i.e., whether the memory page is used for storage of processor instructions). For example, a memory page associated with a memory transaction request may be executable if the execution bit is 0 and not executable if the execution bit is 1. In some embodiments, the execution bit may be a PAE bit. In various embodiments, an execution bit may be part of each page table entry. In various such embodiments, the execution bit may be the most significant bit of each page table entry. In some embodiments, the execution bit may include a No-eXecute (NX) bit of Intel® 64 and Intel® Architecture (IA) 32 paging architectures. In some such embodiments, IOMMU 104 may determine whether a memory page associated with a memory transaction request is executable based on the NX bit.

In some embodiments, IOMMU 104 may be utilized to access physical memory or SVM 106. IOMMU 104 may translate an address associated with a memory transaction request from a guest virtual address to a guest physical address via x86 page tables, and from guest physical address to host physical address, via extended page tables (EPTs). In various embodiments, the page table structures of all MMUs may be the same such that physical memory can be shared seamlessly between CPU 108 and SVM devices 102-1, 102-2, 102-n.

In one or more embodiments, the security checks may utilize the page table structures. For instance, the page table structure may include information (e.g., one or more sets of bits) on whether a particular page is executable. In some such embodiments, this information may be included in one or more of an NX bit, execute disable (XD) bit, SLEE bit of EPT, X bit of EPT, or the like. In various embodiments, IOMMU 104 may perform a security check. In various such embodiments, the security check may ensure that whenever a write request arrives from an SVM device, if the page requested is present (Present bit is 1) and the page is executable (cumulative X bit is 1), an address translation fault (ATF) is generated and the request is terminated. In one or more embodiments described herein cache entries may be generated in response to memory transaction requests that reflect data regarding the memory transaction request. For example, the cache entry may reflect that the page associated with the memory transaction request is not writable (write access bit is 0). In some such examples, this may be reflected by a permission set included in the cache entry. Use of these cache entries may minimize performance overhead by preventing a full-page walk.

As shown in the illustrated embodiment, IOMMU 104 may be communicatively coupled with SVM devices 102-1, 102-2, 102-n and SVM 106. It will be appreciated that any number of SVM devices may be included in various embodiments, as indicated by the 102-n notation. Thus, embodiments described herein may include one or more SVM devices. In some embodiments, an SVM device may include any device or component that utilizes shared virtual memory to enable a CPU process to directly share resources with the device or component. For instance, a CPU and an SVM device may share resources via a unified virtual address space. In various embodiments, an SVM device may include one or more of a hardware accelerator, a graphics processing unit (GPU), a field programmable gate array (FPGA), a system on chip (SOC), a speech processing unit (SPU), an input/output (I/O) device, a digital signal processor (DSP), an application-specific integrated circuit (ASIC), or the like.

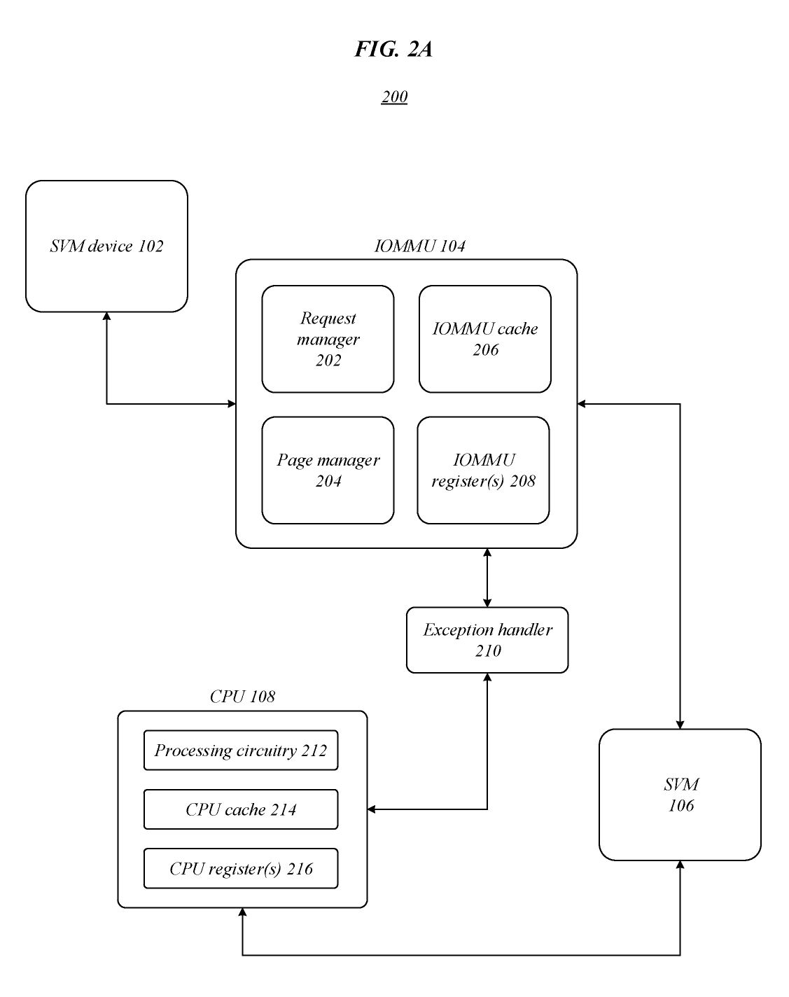

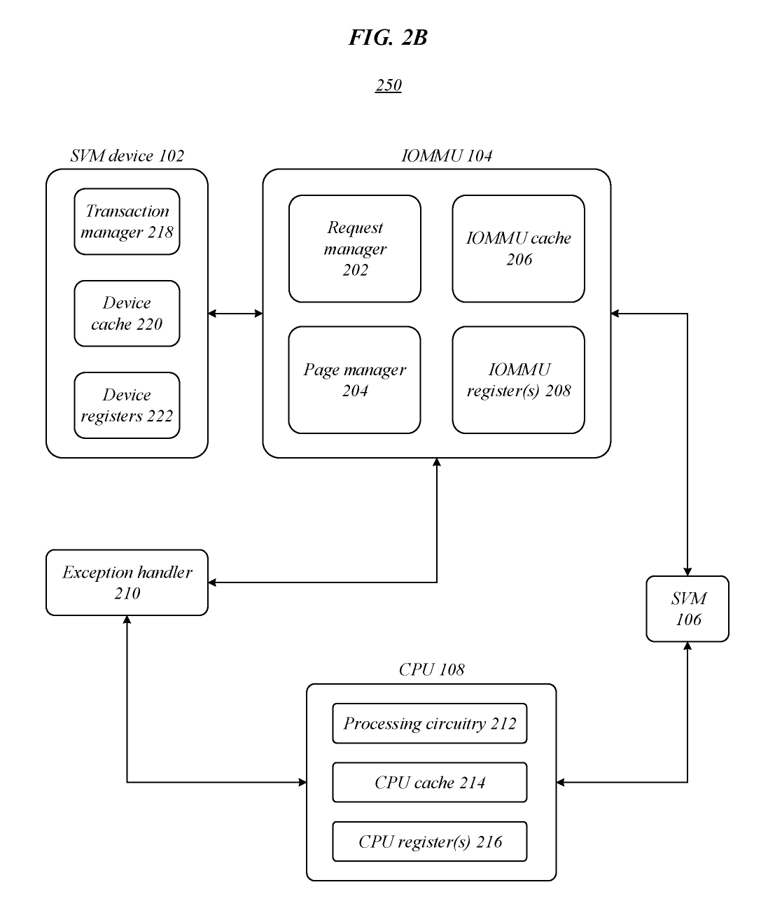

FIG. 2A illustrates an example of an operating environment 200 that may be representative of various embodiments. Operating environment 200 may include exception handler 210 in addition to SVM device 102, IOMMU 104, and SVM 106. In operating environment 200, IOMMU 104 may perform a security check to determine whether to service a memory transaction request received from SVM device 102. In various embodiments, the security check may determine one or more of whether a source of a memory transaction request is an SVM device, whether the memory transaction request is a write request, and whether a memory page associated with a memory transaction request is present in main memory and executable. In various such embodiments, IOMMU 104 may determine the memory transaction request passes the security check and service the memory transaction request unless the source of the memory transaction request is an SVM device, the memory transaction request is a write request, and the memory page associated with the memory transaction request is present in main memory and executable. On the other hand, if IOMMU 104 determines the memory transaction request does not pass the security check and should not be serviced, an access request fault may be generated and passed to exception handler 210. In one or more embodiments, the security check may be performed based on one or more entries in IOMMU cache 206. The embodiments are not limited in this context.

In the illustrated embodiments, IOMMU 104 may include request manager 202, page manager 204, IOMMU cache 206, and one or more IOMMU registers 208. In some embodiments, the components of IOMMU 104 may operate to determine how to handle memory transaction requests received from SVM device 102. For example, the components of IOMMU 104 may operate to restrict memory transaction requests that include write requests originating from SVM device 102 towards a code page of CPU 108, so that SVM device 102 cannot be used to attack and manipulate the behavior of CPU 108. It will be appreciated that while the IOMMU 104 embodiment illustrated in FIG. 2 includes request manager 202, page manager 204, IOMMU cache 206, and IOMMU register(s) 208 components, any type, number, or combination of components may be utilized to realize the functionality of IOMMU 104 described herein.

In various embodiments, when IOMMU 104 receives a memory transaction request, such as a memory access request, request manager 202 may determine the source of the memory transaction request. For example, request manager 202 may determine SVM device 102 was the source of the memory transaction request. In some embodiments, when the source of the memory transaction request is not an SVM device (e.g., SVM device 102-1), request manager 202 may determine the memory transaction request passes the security check.

In some embodiments, if request manager 202 determines the source of the memory transaction request is an SVM device and the memory transaction request includes a write request, page manager 204 or IOMMU cache 206 may be utilized by request manager 202 to identify a memory page associated with the memory transaction request. In various embodiments, page manager 204 may utilize one or more of the memory transaction request, a page table, a page directory, or a page-directory-pointer table to identify the memory page associated with the memory transaction request. Once the memory page associated with the memory transaction request is identified, request manager 202 may utilize page manager 204 and/or IOMMU cache 206 to determine whether the memory page is present in main memory and whether the memory page is executable.

In various embodiments, whether the memory page associated with the memory transaction request is present and/or executable may be determined based on one or more informational bits, such as in a page table entry or a cache entry. For instance, page manager 204 may identify a page table entry associated with the memory transaction request. In such instances, page manager 204 may determine whether the memory page associated with the memory transaction request is present based on a first bit in the page table entry and whether the memory page associated with the memory transaction request is executable based on a second bit in the page table entry. In some embodiments, page manager 204 may pass an indication of whether the memory page associated with the memory transaction request is present in main memory and/or executable to request manager 202. In one or more embodiments, request manager 202 may make one or more of these determinations based on one or more entries in IOMMU cache 206. In one or more such embodiments, this may prevent page manager 204 from performing additional page walks. In some embodiments, CPU cache 214 may be used in a manner similar to IOMMU cache 206 or device cache 220 (see FIG. 2B). In various embodiments, based on the determination of whether the memory page associated with the memory transaction request is present in main memory and executable, request manager 202 may determine whether the memory transaction request passes the security check. For example, if the memory page associated with the memory transaction request is either not present in main memory or is not executable, request manager 202 may determine the memory transaction request passes the security check. However, if the memory page associated with the memory transaction request is present in main memory and is executable, an access request fault may be generated, such as by request manager 202 or page manager 204. In various embodiments, the access request fault may then be passed to exception handler 210. In various such embodiments, exception handler 210 may terminate the memory transaction request in response to the access request fault. In one or more embodiments, exception handler 210 may be implemented via CPU 108. In some embodiments, exception handler 210 may be part of an operating system (OS) or virtual machine monitor (VMM) executed by CPU 108.

In various embodiments, CPU 108 may include processing circuitry 212, CPU cache 214, and CPU register(s) 216. In one or more embodiments, CPU 108 may implement one or more of an operating system (OS) or a virtual machine monitor (VMM). In some embodiments, one or more security checks described herein may be enabled or activated via one or more registers (e.g., IOMMU register(s) 208, CPU register(s) 216, and device registers 222 (see FIG. 2B). In various embodiments, IOMMU registers 208 may include bits that indicate whether the particular version of IOMMU is capable of performing one or more of the security checks. For instance, a bit may be allocated in an extended capability register included in IOMMU registers 208 to indicate the capability of IOMMU 104. In another instance, a bit may be allocated in a global command register included in CPU registers 216. In such other instances, the bit may be used by software to activate or deactivate one or more security checks. In various embodiments, one or more of the registers described herein may be memory mapped. In various such embodiments, the memory mapped register may be set by hardware, and software may only have read access.

FIG. 2B illustrates an example of an operating environment 250 that may be representative of various embodiments. In one or more embodiments described herein, operating environment 250 may be set up to utilize the ATS protocol. To this end, the SVM device 102 of operating environment 250 may include transaction manager 218, device cache 220, and device registers 222. In various embodiments, the ATS protocol may provide a mechanism that allows SVM device 102 to participate in memory translation processes, such as by providing its own cache (e.g., device cache 220) for its own memory transactions. In operating environment 250, IOMMU 104 may perform a security check to determine whether to service a memory transaction request received from SVM device 102. In various embodiments, the security check may determine one or more of whether a source of a memory transaction request is an SVM device, whether the memory transaction request is a translation request requiring write permissions, and whether a destination address associated with the memory transaction request is executable. In some embodiments, IOMMU 104 may generate a translation completion with read and write access when the destination address is not executable and a translation completion with read-only access when the destination address is executable. The embodiments are not limited in this context.

In one or more embodiments, having a cache integrated with SVM device 102 may prevent exces sing demands on IOMMU cache 206 by distributing address translation caching responsibilities. In one or more such embodiments, distributing address translation caching responsibilities may allow SVM devices utilizing integrated caches to have less performance dependency on IOMMU cache 206 size. Further, integrated caches may ensure optimal access latency by enabling pre-translated memory transaction requests to be sent to the MMU.

In some embodiments, the ATS protocol may separate memory transaction requests into two types: memory access requests and memory translation requests. In various embodiments, memory access requests are used from an SVM device to send a memory read/write request to a translation agent, such as IOMMU 104. In various such embodiments, memory access requests may include an address type (AT) field that indicates the type of address (e.g., translated or untranslated) that is present, such as in the request header. In some embodiments, translation requests are used by an SVM device to translate between different address mappings, such as from a virtual address into a physical address.

In various embodiments, memory transaction requests in operating environment 250 may proceed as follows. The ATS and SVM access control mechanisms may by initialized, such as by the OS or VMM depending on configuration. In some embodiments, the ATS and SVM access control mechanisms may be initialized by setting an ATS extended capability structure, an SVM access control capability register, and page tables in one or more IOMMUs. Once initialized, when a memory transaction is received by IOMMU 104, one or more checks may be performed to determine if the request is of translation request type (e.g., AT bit is 01b), if the request is initiated by an SVM device, or if the device is requesting write permissions (e.g., no write (NW) bit is 0).

In one or more embodiments, if any of those requirements are not met, then IOMMU 104 performs a legacy memory access and applies the existing SVM access control mechanism. However, if all those requirements are met, then IOMMU 104 may perform a page walk for the requested page and check if the cumulative execute permission of the page is set (e.g., via considering one or more of the NXE, SLEE, EX, and/or X bits). If the requested page is executable, then IOMMU 104 may respond to the SVM device with a translation completion message granting read-only permissions (e.g., RW bits set to 10b), while, if the requested page is not executable, then a translation completion message granting read and write permissions (e.g., RW bits set to 11b). Next if the SVM device requested translations of multiple pages, then the next requested page is processed similarly until all the memory translation requests are served. Thus, in various embodiments, translation requests originating from SVM device 102 with write permission will be denied by IOMMU 104 if the target page is marked as executable by CPU 108. In various such embodiments, existing write permissions may be ignored. In one or more embodiments, SVM device 102 may not be allowed to modify code pages (e.g., CPU 108 code pages) to ensure code integrity.

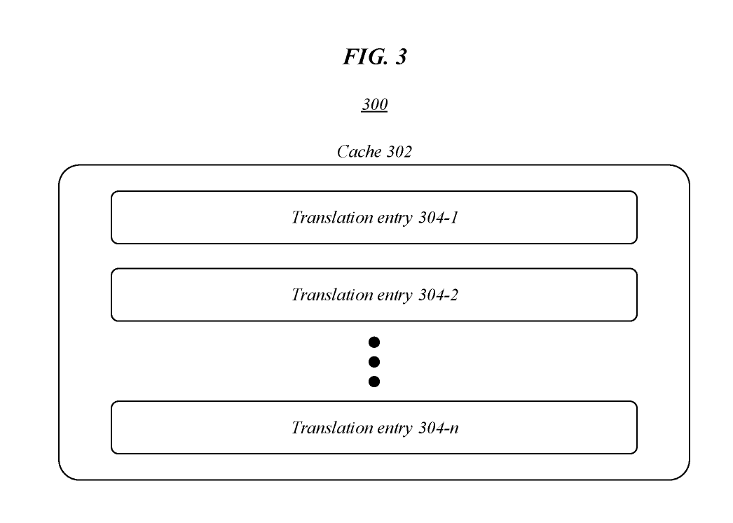

FIG. 3 illustrates an example of an operating environment 300 that may be representative of various embodiments. In one or more embodiments described herein, operating environment 300 may include cache 302 with one or more translation entries 304-1, 304-2, 304-n. In various embodiments described herein, translation entries 304 may be utilized to perform a security check on a memory transaction request. In various such embodiments, performance of the security check utilizing cache 302 may improve efficiency of the security check by reducing a number of page walks. In one or more embodiments, cache 302 may be the same or similar to IOMMU cache 206, CPU cache 214, and/or device cache 220. In some embodiment, cache 302 may be a translation lookaside buffer (TLB). Embodiments are not limited in this context.

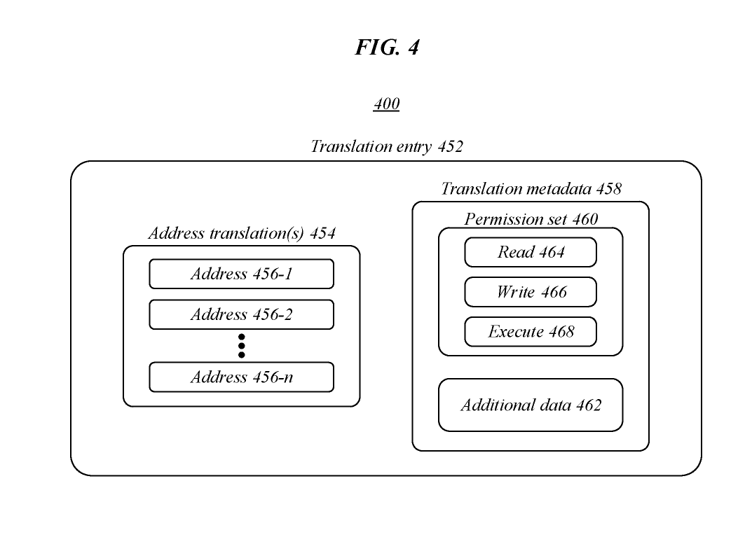

FIG. 4 illustrates an example of an operating environment 400 that may be representative of various embodiments. In one or more embodiments described herein, operating environment 400 may include translation entry 452 with address translations 454 and translation metadata 458. In various embodiments, translation entry 452 may be the same or similar to one or more of translation entry 404-1, 404-2, 404-n. In some embodiments, address translations 454 may include one or more corresponding addresses 456-1, 456-2, 456-n. In some such embodiments, each of addresses 456 may correspond to a different address mapping, thereby enabling translations between the different address mappings. For instance, address 456-1 may correspond to a virtual address, address 456-2 may correspond to a linear address, and address 456-n may correspond to a physical address. Embodiments are not limited in this context.

In one or more embodiments, a translation entry associated with a memory transaction request may be identified, such as by request manager 202, using address translations 454. For example, the memory transaction request may include address 456-1. In some embodiments, translation entry 452 may also include translation metadata 458. In various embodiments described herein, translation metadata 458 may be utilized to perform a security check on a memory transaction request. For instance, a security check may include a determination of whether permission set 460 allows or permits a request memory transaction. In some embodiments, permission set 460 may refer to how the contents of an associated memory location may be manipulated. In the illustrated embodiments, permission set 460 may include the following permissions: read 464, write 466, execute 468. In one or more embodiments, each permission may include a bit, and if the bit is set the associated permission is allowed, but if the bit is not set the associated permission is not allowed. For instance, if read 464 and execute 468 permissions are set, but write 466 permission is not set, then the associated memory location may be read (e.g., by IOMMU 104) and executed (e.g., by CPU 108), however, the associated memory location may not be written to. Additionally, in some embodiments, translation metadata 458 may include additional data 462. In some such embodiments, additional data 462 may provide more information regarding a chunk of memory associated with the translation entry 452, such as the length of the chunk. In one or more embodiments, translation entry 452 may comprise a set of bits. In one or more such embodiments, translation metadata 458 may include one or more subsets of the set of bits.

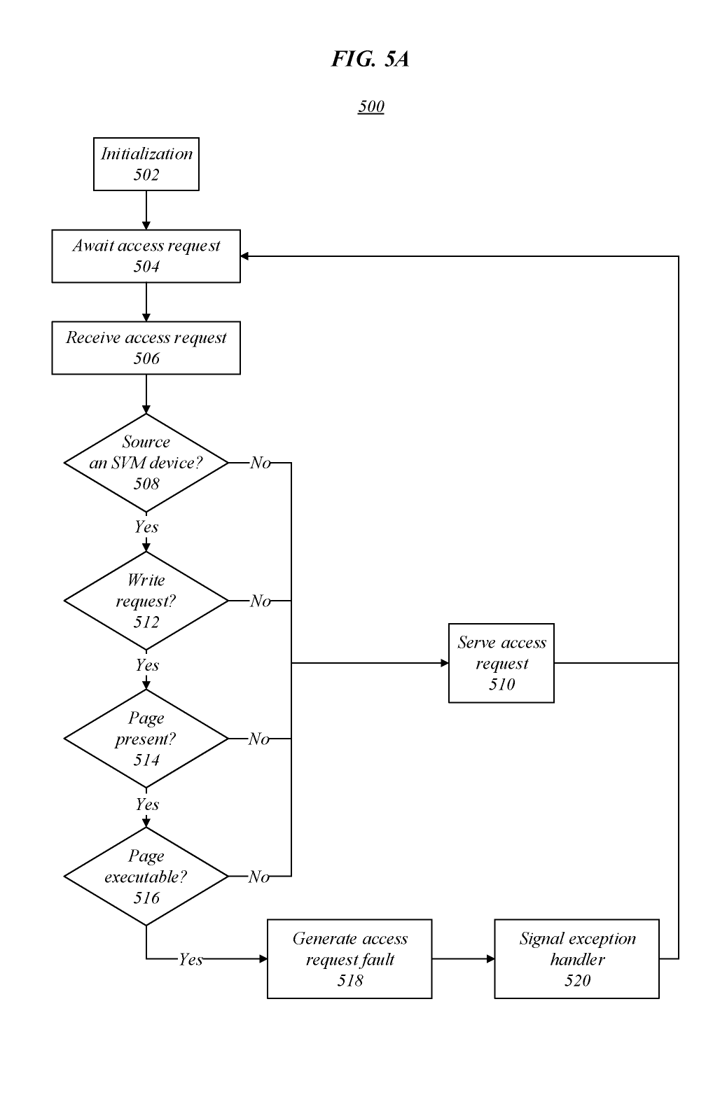

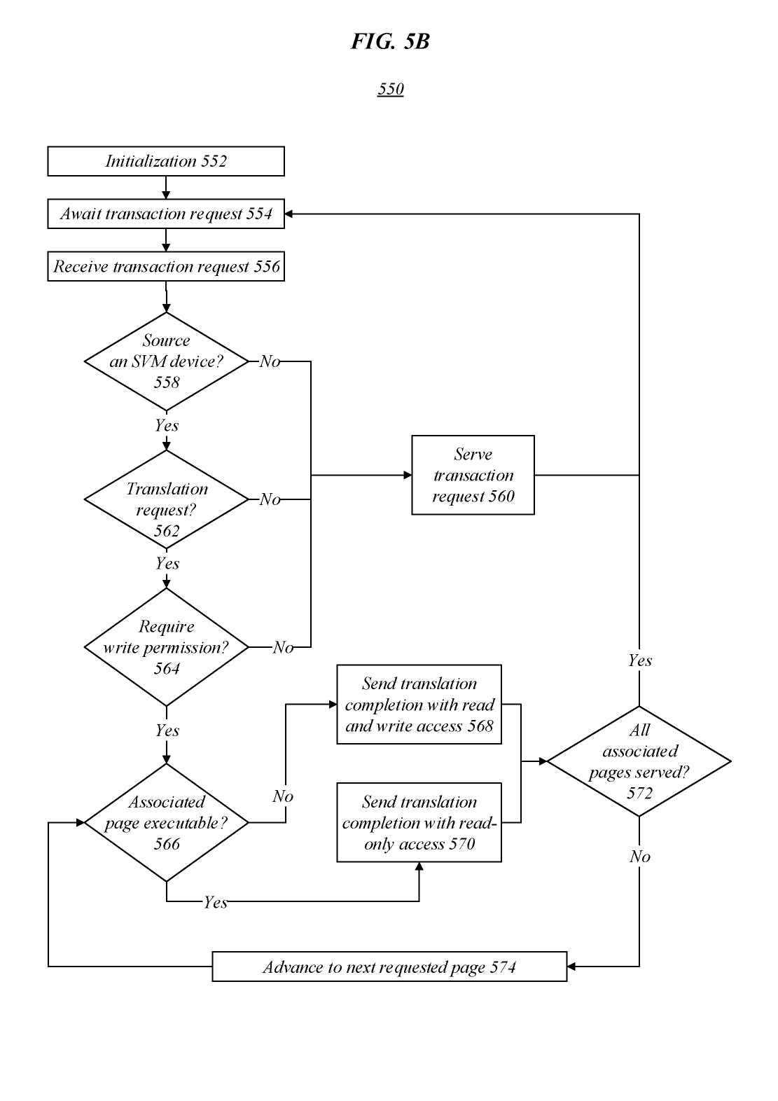

FIG. 5A illustrates one embodiment of a logic flow 500, which may be representative of operations that may be executed in various embodiments in conjunctions with providing shared virtual memory (SVM) access protection. The logic flow 500 may be representative of some or all of the operations that may be executed by one or more components of operating environments 100, 200, or 250 of FIGS. 1-2B, such as IOMMU 104. The embodiments are not limited in this context.

In the illustrated embodiment shown in FIG. 5A, the logic flow 500 may begin at block 502. At block 502 “initialization” the IOMMU may be initialized. For example, the initialization may be part of a Basic Input/output System (BIOS) boot up process. In some embodiments, the initialization may include the BIOS boot up process, as well as additional functionality that the BIOS needs to do to enable the security check, such as setting up a page table, a page directory, a page-directory-pointer, an informational bit, or the like. In various embodiments, initialization may prepare IOMMU 104 to monitor a memory path between SVM devices 102-1, 102-2, 102-n and SVM 106. In some embodiments, initialization may prepare a plurality of MMUs to monitor each of a plurality of memory paths. In one or more embodiments, initialization may include setting or evaluating one or more register values, such as one or more values in IOMMU register(s) 208, CPU register(s) 216, and/or device register(s) 222. In one or more such embodiments, the registers may include one or more of an extended capability register, a global command register, or a SVM access control capability register.

Proceeding to block 504 “await access request” receipt of a memory transaction request may be awaited. In various embodiments, monitoring the memory path between SVM devices and a shared virtual memory may include waiting for receipt of a memory transaction request. For example, IOMMU 104 may await receipt of a memory transaction request by monitoring the memory path between SVM devices 102-1, 102-2, 102-n and SVM 106. In some embodiments, block 504 may be the first block in a continuous loop in which a device sends an access request to memory through IOMMU 104.

At block 506 “receive access request” an access request may be received. For example, IOMMU 104 may receive a memory transaction request from SVM device 102-1, 102-2, or 102-n. In various embodiments, the access request may be targeted at reading or writing data to or from SVM 106. In some embodiments, request manager 202 may receive the memory transaction request from SVM device 102-1.

Continuing to block 508 “source an SVM device?”, it may be determined if the source of the received memory transaction request is an SVM device. For example, IOMMU 104 may determine if the source of a memory transaction request is SVM device 102-1, 102-2, or 102-n or a non-SVM device. In some embodiments, request manager 202 may determine the source of a memory transaction request. In various embodiments, the source of a memory transaction request may be determined based on one or more bits in the memory transaction request. For instance, the memory transaction request may include a unique identifier that is used by IOMMU 104 to determine the source of the memory transaction request.

Referring back to block 508, if the source is not an SVM device, then logic flow 500 may proceed to block 510 “serve access request”. For instance, IOMMU 104 may read or write content to or from SVM 106 in response to the source of the memory transaction request not being an SVM device (e.g., not SVM device 102-1, 102-2, or 102-n). In some embodiments, when the source of a memory transaction request is not an SVM device, IOMMU 104 may determine the memory transaction request passes the security check. In various embodiments serving the access request may proceed as it would in legacy systems. In some embodiments, once the memory transaction request has been served, logic flow 500 may return to block 504 “await access request” as part of a continuous loop. In some such embodiments, the continuous loop may only be exited upon a power state change or a system settings change.

In some embodiments, serving the memory transaction request may include utilizing IOMMU 104 (e.g., request manager 202, page manager 204, and/or IOMMU cache 206) to map a device-visible virtual address included in the memory transaction request to a corresponding physical address according to the paging architecture. In some such embodiments, IOMMU 104 may utilize one or more of the memory transaction request, a page table, a page directory, or a page-directory-pointer table to translate a device-visible virtual address to a physical address and/or identify a memory page associated with a memory transaction request. For instance, SVM device 102-1 may send a memory transaction request to IOMMU 104 that includes a device-visible virtual address. IOMMU 104 may then identify or determine one or more of a cache entry (e.g., translation entry 452), a page-directory pointer, a page directory entry, a page table entry, a memory page, and a physical address associated with the memory transaction request based on the virtual address. In various embodiments, IOMMU 104 may retrieve and/or store data in SVM 106 as part of serving the memory transaction request.

Referring again to block 508, if the source is an SVM device, the logic flow 500 may proceed to block 512 “write request?”. For instance, IOMMU 104 may determine whether the memory transaction request from SVM 102-1 includes a write request. In various embodiments, request manager 202 may determine whether the memory transaction request is a write request. In some embodiments, when the memory transaction request is not a write request, IOMMU 104 (e.g., request manager 202) may determine the memory transaction request passes the security check. In various embodiments, when a memory transaction request is not a write request, logic flow 500 may proceed to block 510 “serve access request” and continue as described above. However, if the memory transaction request is a write request, logic flow 500 may proceed to block 514.

At block 514 “Page present?” it may be determined whether a memory page associated with the memory transaction request is present in main memory. For example, IOMMU 104 may utilize page manager 204 or cache 302 to determine whether a memory page associated with a memory transaction request is present in main memory. In some such examples, cache 302 may include one or more of IOMMU cache 206, SPU cache 214, or device cache 220. In various embodiments, main memory may refer to random access memory (RAM). In some embodiments, IOMMU 104 may utilize one or more of a memory transaction request, a cache entry (e.g., translation entry 452), a page table, a page directory, or a page-directory-pointer table supported by the paging and/or caching architecture to determine whether the memory page associated with the memory transaction request is present in main memory. In various embodiments, a paging and/or caching architecture may be used that supports an informational bit (e.g., present bit) to indicate whether a memory page is present in main memory. For example, a memory page associated with a memory transaction request may be present in main memory if the present bit is 1 and not present in main memory if the present bit is 0. In some embodiments, a present bit may be part of each page table entry. In some such embodiments, the present bit may be the least significant bit of each page table entry. In various embodiments, the present bit may be a PAE bit. In one or more embodiments, the present bit may be included in a cache entry, such as translation entry 452.

Referring back to block 514, if the page is not present, logic flow 500 may proceed to block 510 “serve access request” and continue as described above. In some embodiments, when the memory page associated with a memory transaction request is not present in main memory, block 510 may include paging the memory page associated with the memory transaction request into main memory. In various embodiments, when a memory page associated with a memory transaction request is not present in main memory, IOMMU 104 may determine the memory transaction request passes the security check. On the other hand, if the memory page associated with the memory transaction request is present in main memory, logic flow 500 may proceed to block 516.

At block 516 “page executable” it may be determined whether the memory page associated with a memory transaction request is executable. For example, IOMMU 104 may utilize page manager 204 or cache 302 to determine whether a memory page associated with a memory transaction request is executable. In some such examples, cache 302 may include one or more of IOMMU cache 206, SPU cache 214, or device cache 220. In various embodiments, IOMMU 104 may utilize one or more of a memory transaction request, a cache entry (e.g., translation entry 452), a page table, a page directory, or a page-directory-pointer table supported by the paging and/or caching architecture to determine whether the memory page associated with the memory transaction request is executable. In some embodiments, a paging and/or caching architecture may be used that supports an informational bit (e.g., execution bit) to indicate whether a memory page is executable. In some such embodiments, the informational bit may be one or more bits in a cache entry, such as translation entry 452. In various embodiments, the execution bit may define whether the associated memory page can be used by a CPU (e.g., CPU 108) to execute code from. In one or more embodiments, the execution bit may include one or more of an NXE, SLEE, XD, or X bit.

In some embodiments, the execution bit may be used by IOMMU 104 to determine whether a memory page associated with a memory transaction request is executable (i.e., whether the memory page is used for storage of processor instructions). For example, a memory page associated with a memory transaction request may be executable if the execution bit is 0 and not executable if the execution bit is 1. In various embodiments, the execution bit may be a PAE bit. In some embodiments, an execution bit may be part of each page table entry. In various such embodiments, the execution bit may be the most significant bit of each page table entry. In some embodiments, the execution bit may include a No-eXecute (NX) bit of Intel® 64 and IA-32 paging architecture.

Referring back to block 516, if the page is not executable, logic flow 500 may proceed to block 510 “serve access request” and continue as described above. In various embodiments, when a memory page associated with a memory transaction request is not executable, IOMMU 104 may determine the memory transaction request passes the security check. On the other hand, if the memory page associated with the memory transaction request is executable, logic flow 500 may proceed to block 518.

At block 518 “generate access request fault” an access request fault may be generated. For example, IOMMU 104 may generate an access request fault when at block 508 the source is identified as an SVM device (e.g., SVM device 102-1, 102-2, 102-n), at block 512 the memory transaction request is determined to include a write request, at block 514 the memory page associated with the memory transaction request is present in main memory, and at block 516 the memory page associated with the memory transaction request is executable. In various embodiments, generation of the access request fault may be in response to IOMMU 104 determining the memory transaction request does not pass the security check. In some embodiments, request manager 202 may produce the access request fault. In one or more embodiments, page manager 204 may produce the access request fault.

Proceeding to block 520 “signal exception handle” an exception handler may be made aware of the access request fault. For example, IOMMU 104 (e.g., request manager 202 and/or page manager 204) may generate an access request fault that includes an interrupt signal to make exception handler 210 aware of the access request fault. In some embodiments, exception handler 210 may be part of an OS. In various embodiments, exception handler 210 may terminate the memory transaction request in response to the access request fault. In some embodiments, once the exception handler has been signaled of the access request fault, logic flow 500 may return to block 504 “await access request” as part of a continuous loop.

FIG. 5B illustrates one embodiment of a logic flow 550, which may be representative of operations that may be executed in various embodiments in conjunctions with providing shared virtual memory (SVM) access protection. The logic flow 550 may be representative of some or all of the operations that may be executed by one or more components of operating environments 100, 200, or 250 of FIGS. 1-2B, such as IOMMU 104. The embodiments are not limited in this context.

In the illustrated embodiment shown in FIG. 5B, the logic flow 550 may begin at block 552. At block 552 “initialization” the IOMMU may be initialized. For example, the initialization may be part of a Basic Input/output System (BIOS) boot up process. In some embodiments, the initialization may include the BIOS boot up process, as well as additional functionality that the BIOS needs to do to enable the security check, such as setting up a page table, a page directory, a page-directory-pointer, an informational bit, or the like. In various embodiments, initialization may prepare IOMMU 104 to monitor a memory path between SVM devices 102-1, 102-2, 102-n and SVM 106. In some embodiments, initialization may prepare a plurality of MMUs to monitor each of a plurality of memory paths. In one or more embodiments, initialization may include setting or evaluating one or more register values, such as one or more values in IOMMU register(s) 208, CPU register(s) 216, and/or device register(s) 222. In one or more such embodiments, the registers may include one or more of an extended capability register, a global command register, or a SVM access control capability register.

Proceeding to block 554 “await transaction request” receipt of a memory transaction request may be awaited. In various embodiments, monitoring the memory path between SVM devices and a shared virtual memory may include waiting for receipt of a memory transaction request. For example, IOMMU 104 may await receipt of a memory transaction request by monitoring the memory path between SVM devices 102-1, 102-2, 102-n and SVM 106. In some embodiments, block 554 may be the first block in a continuous loop in which a device sends an access request to memory through IOMMU 104.

At block 556 “receive transaction request” a transaction request may be received. For example, IOMMU 104 may receive a memory transaction request from SVM device 102-1, 102-2, or 102-n. In various embodiments, the transaction request may be targeted at reading or writing data to or from SVM 106 or translating between different address mappings. In one or more embodiments, the transaction requests may adhere to the ATS protocol. In some embodiments, request manager 202 may receive the memory transaction request from SVM device 102-1.

Continuing to block 558 “source an SVM device?”, it may be determined if the source of the received memory transaction request is an SVM device. For example, IOMMU 104 may determine if the source of a memory transaction request is SVM device 102-1, 102-2, or 102-n or a non-SVM device. In some embodiments, request manager 202 may determine the source of a memory transaction request. In various embodiments, the source of a memory transaction request may be determined based on one or more bits in the memory transaction request. For instance, the memory transaction request may include a unique identifier that is used by IOMMU 104 to determine the source of the memory transaction request. Referring back to block 558, if the source is not an SVM device, then logic flow 550 may proceed to block 560 “serve transaction request”. For instance, IOMMU 104 may read or write content to or from SVM 106 in response to the source of the memory transaction request not being an SVM device (e.g., not SVM device 102-1, 102-2, or 102-n). In some embodiments, when the source of a memory transaction request is not an SVM device, IOMMU 104 may determine the memory transaction request passes the security check. In various embodiments serving the access request may proceed as it would in legacy systems. In some embodiments, once the memory transaction request has been served, logic flow 550 may return to block 554 “await transaction request” as part of a continuous loop. In some such embodiments, the continuous loop may only be exited upon a power state change or a system settings change.

In some embodiments, serving the memory transaction request may include utilizing IOMMU 104 (e.g., request manager 202, page manager 204, and/or IOMMU cache 206) to map a device-visible virtual address included in the memory transaction request to a corresponding physical address according to the paging and/or caching architecture. In some such embodiments, IOMMU 104 may utilize one or more of the memory transaction request, a page table, a page directory, or a page-directory-pointer table to translate a device-visible virtual address to a physical address and/or identify a memory page associated with a memory transaction request. For instance, SVM device 102-1 may send a memory transaction request to IOMMU 104 that includes a device-visible virtual address. IOMMU 104 may then identify or determine one or more of a cache entry (e.g., translation entry 452), a page-directory pointer, a page directory entry, a page table entry, a memory page, and a physical address associated with the memory transaction request based on the virtual address. In various embodiments, IOMMU 104 may retrieve and/or store data in SVM 106 as part of serving the memory transaction request.

Referring again to block 558, if the source is an SVM device, the logic flow 550 may proceed to block 562 “translation request?”. For instance, IOMMU 104 may determine whether the memory transaction request from SVM 102-1 is a translation request. In various embodiments, request manager 202 may determine whether the memory transaction request is a translation request. In some embodiments, when the memory transaction request is not a translation request, IOMMU 104 (e.g., request manager 202) may determine the memory transaction request passes the security check. In various embodiments, when a memory transaction request is not a translation request, logic flow 550 may proceed to block 560 “serve transaction request” and continue as described above. However, if the memory transaction request is a translation request, logic flow 550 may proceed to block 564.

At block 564 “require write permission?” it may be determined whether the translation request is associated with a write request or requires write permission. For instance, IOMMU 104 may determine whether the memory translation request from SVM 102-1 requires write permission or is associated with a write request. In various embodiments, request manager 202 may determine whether the memory translation request requires write permission or is associated with a write request. In some embodiments, when the memory translation request does not require write permission or is not associated with a write request, IOMMU 104 (e.g., request manager 202) may determine the memory transaction request passes the security check. In various embodiments, when a memory transaction request does not require write permission or is not associated with a write request, logic flow 550 may proceed to block 560 “serve transaction request” and continue as described above. However, if the memory transaction request requires write permission or is associated with a write request, logic flow 550 may proceed to block 566.

At block 566 “associated page executable?” it may be determined whether the memory page associated with a memory translation request is executable. For example, IOMMU 104 may utilize one or more of request manager 202, page manager 204, or cache 302 to determine whether a memory page associated with a memory transaction request is executable. In some such examples, cache 302 may include one or more of IOMMU cache 206, SPU cache 214, or device cache 220. In various embodiments, IOMMU 104 may utilize one or more of a memory transaction request, a cache entry (e.g., translation entry 452), a page table, a page directory, or a page-directory-pointer table supported by the paging and/or caching architecture to determine whether the memory page associated with the memory transaction request is executable. In some embodiments, a paging and/or caching architecture may be used that supports an informational bit (e.g., execution bit) to indicate whether a memory page is executable. In some such embodiments, the informational bit may be one or more bits in a cache entry, such as translation entry 452. In various embodiments, the execution bit may define whether the associated memory page can be used by a CPU (e.g., CPU 108) to execute code from. In one or more embodiments, the execution bit may include one or more of an NXE, SLEE, XD, or X bit.

In some embodiments, the execution bit may be used by IOMMU 104 to determine whether a memory page associated with a memory transaction request is executable (i.e., whether the memory page is used for storage of processor instructions). For example, a memory page associated with a memory transaction request may be executable if the execution bit is 0 and not executable if the execution bit is 1. In various embodiments, the execution bit may be a PAE bit. In some embodiments, an execution bit may be part of each page table entry. In various such embodiments, the execution bit may be the most significant bit of each page table entry. In some embodiments, the execution bit may include a No-eXecute (NX) bit of Intel® 64 and IA-32 paging architecture.

Referring back to block 566, if the page is not executable, logic flow 550 may proceed to block 568 “send translation completion with read and write access”. On the other hand, if the page is executable, logic flow 550 may proceed to block 570 “send translation completion with read-only access”. In various embodiments, when a memory page associated with a memory transaction request is not executable, IOMMU 104 may determine the memory transaction request passes the security check, resulting in read and write permissions being granted. In some embodiments, when a memory page associated with a memory transaction request is executable, IOMMU 104 may determine the memory transaction request does not pass the security check, resulting in read-only permission being granted. In either case, permissions being granted may be communicated in a translation completion. In one or more embodiments, a translation completion may include an address in a first mapping that corresponds an address in a second mapping that was included in the memory translation request. For instance, the address in the first mapping may include a physical address and the address in the second mapping may include a virtual address.

Proceeding to block 572 “all associated pages served?”, it may be determined if all pages associated with the translation request have been served. If all the associated pages have not been served, then logic flow 550 may proceed to block 574 “advance to next requested page”, return to block 566 “associated page executable?”, and proceed as described above. On the other hand, if all the associated pages have been served, logic flow 550 may proceed to block 554 “await transaction request” and proceed as described above.

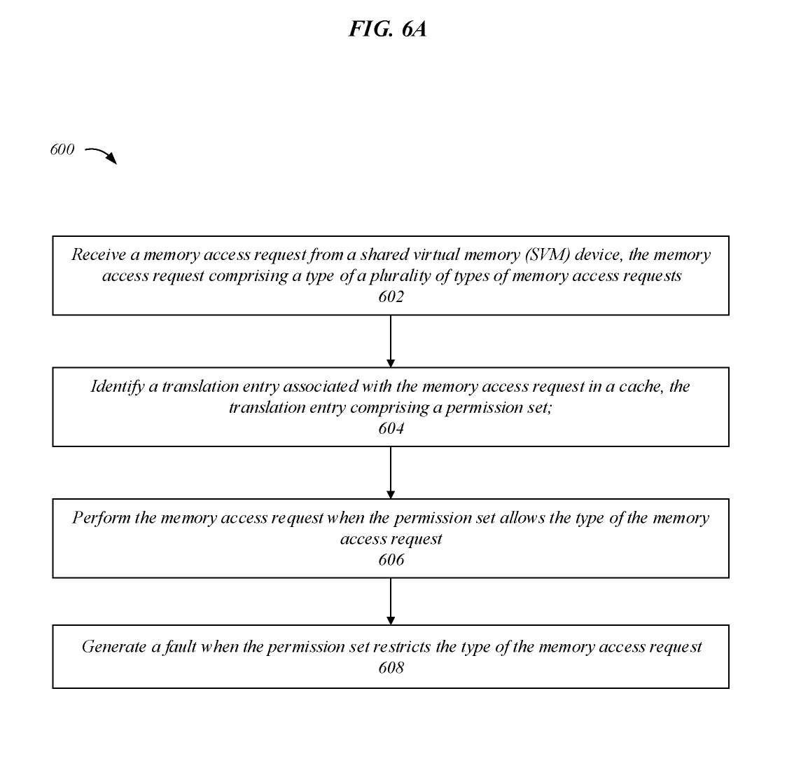

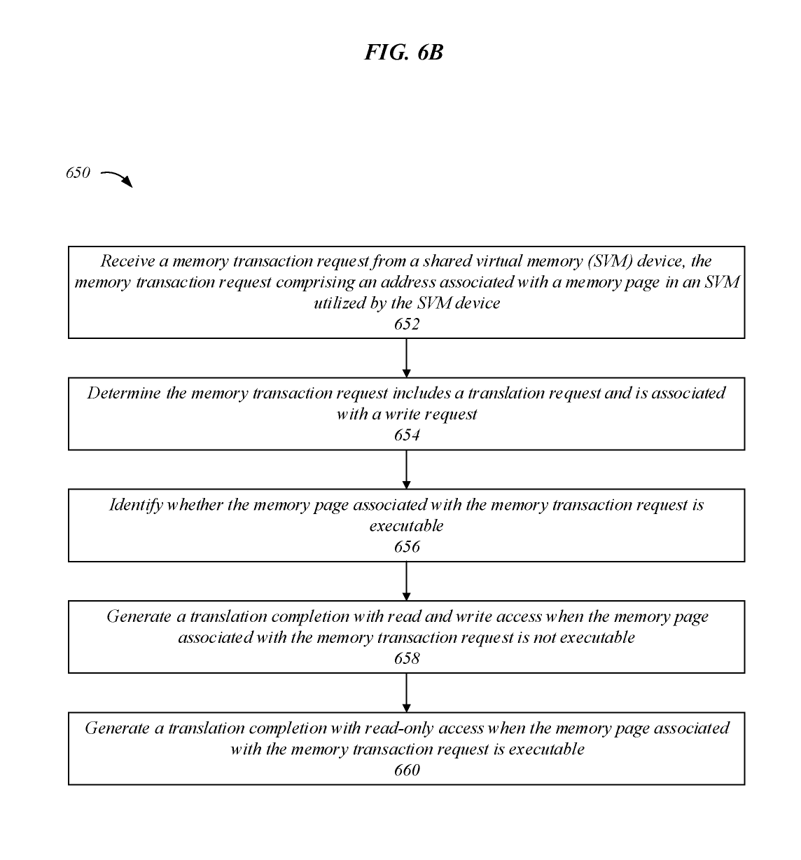

FIG. 6A illustrates one embodiment of a logic flow 600, which may be representative of operations that may be executed in various embodiments in conjunctions with providing shared virtual memory (SVM) access protection. The logic flow 600 may be representative of some or all of the operations that may be executed by one or more components of operating environments 100, 200, or 250 of FIGS. 1-2B, such as IOMMU 104. The embodiments are not limited in this context.

In the illustrated embodiment shown in FIG. 6A, the logic flow 600 may begin at block 602. At block 602 “receive a memory access request from a shared virtual memory (SVM) device, the memory access request comprising a type of a plurality of types of memory access requests” a memory access request of one or a plurality of types may be received from a SVM device. For instance, IOMMU 104 may receive a memory access request of a read or write type. In some embodiments, the memory access request may be received from one of SVM devices 102-1, 102-2, 102-n.

Continuing to block 604 “identify a translation entry associated with the memory access request in a cache, the translation entry comprising a permission set” a translation entry including a permission set that is associated with the memory access request may be identified in a cache. For instance, request manager 202 may identify a translation entry (e.g., translation entry 452) with permission set 460 in IOMMU cache 206. In some embodiments, the associated translation entry may be identified by IOMMU 104 based on an address included in the memory access request. For example, the memory access request may include a virtual address that is used to identify the associated translation entry.

Proceeding to block 606 “perform the memory access request when the permission set allows the type of the memory access request” the memory access request may be performed when the permission set allows the type of the memory access request. For instance, if the memory access request is a read request and permission set 460 includes read 464 permission that is set, then the memory access request may be performed. At block 608 “generate a fault when the permission set restricts the type of the memory access request” a fault may be generated when the permission set restricts the type of the memory access request. For example, if the memory access request is a write request and permission set 460 includes execute 468 permission that is set, then the memory access request may not be performed. In other words, as described herein, memory access requests may not cause a memory location that is executable to be written to.

FIG. 6B illustrates one embodiment of a logic flow 650, which may be representative of operations that may be executed in various embodiments in conjunctions with providing shared virtual memory (SVM) access protection. The logic flow 650 may be representative of some or all of the operations that may be executed by one or more components of operating environments 100, 200, or 250 of FIGS. 1-2B, such as IOMMU 104. The embodiments are not limited in this context.

In the illustrated embodiment shown in FIG. 6B, the logic flow 650 may begin at block 652. At block 652 “receive a memory transaction request from a shared virtual memory (SVM) device, the memory access request comprising an address associated with a memory page in an SVM utilized by the SVM device” a memory transaction request comprising an address associated with a memory page in an SVM utilized by the SVM device may be received. For instance, IOMMU may receive a memory transaction request from SVM device 102-n. Further, SVM device 102-n may utilize SVM 106. In some embodiments, the memory transaction request may adhere to the ATS protocol. Proceeding to block 654 “determine the memory transaction request includes a translation request and is associated with a write request” the memory transaction request may be determined to include a translation request and be associated with a write request. In various embodiments, a memory transaction request may include a memory access request or a memory translation request. In one or more embodiments, if the memory transaction request includes a translation request and is associated with a write request, logic flow 650 may proceed to block 656.

At block 656 “identify whether the memory page associated with the memory transaction request is executable” whether the memory page associated with the memory transaction request is executable may be identified. The determination of whether a memory page is executable may proceed as described above, such as with respect to block 516 of FIG. 5A or block 566 of FIG. 5B. Continuing to block 658 “generate a translation completion with read and write access when the memory page associated with the memory transaction request is not executable” a translation completion with read and write access may be generated when the memory page associated with the memory transaction request is not executable. For instance, IOMMU 104 may generate a translation completion with read and write access for SVM device 102-n in response to receiving a memory transaction request from SVM device 102-n that is associated with a memory page that is not executable. At to block 660 “generate a translation completion with read-only access when the memory page associated with the memory transaction request is executable” a translation completion with read-only access may be generated when the memory page associated with the memory transaction request is executable. For instance, IOMMU 104 may generate a translation completion with read-only access for SVM device 102-2 in response to receiving a memory transaction request from SVM device 102-2 that is associated with a memory page that is executable.

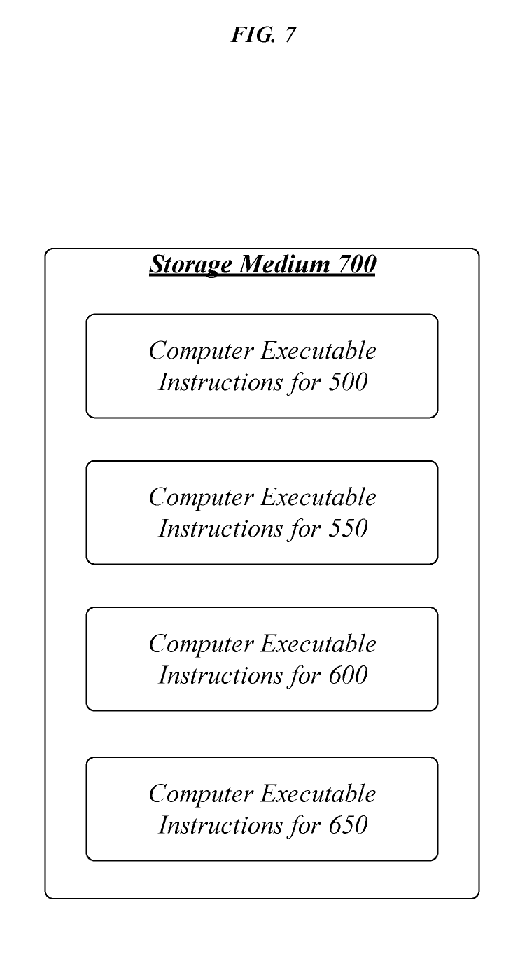

FIG. 7 illustrates an embodiment of a storage medium 700. Storage medium 700 may comprise any non-transitory computer-readable storage medium or machine-readable storage medium, such as an optical, magnetic or semiconductor storage medium. In various embodiments, storage medium 700 may comprise an article of manufacture. In some embodiments, storage medium 700 may store computer-executable instructions, such as computer-executable instructions to implement one or more of logic flows or operations described herein, such as with respect to logic flow 500 of FIG. 5A, logic flow 550 of FIG. 5B, logic flow 600 of FIG. 6A, and logic flow 650 of FIG. 6B. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

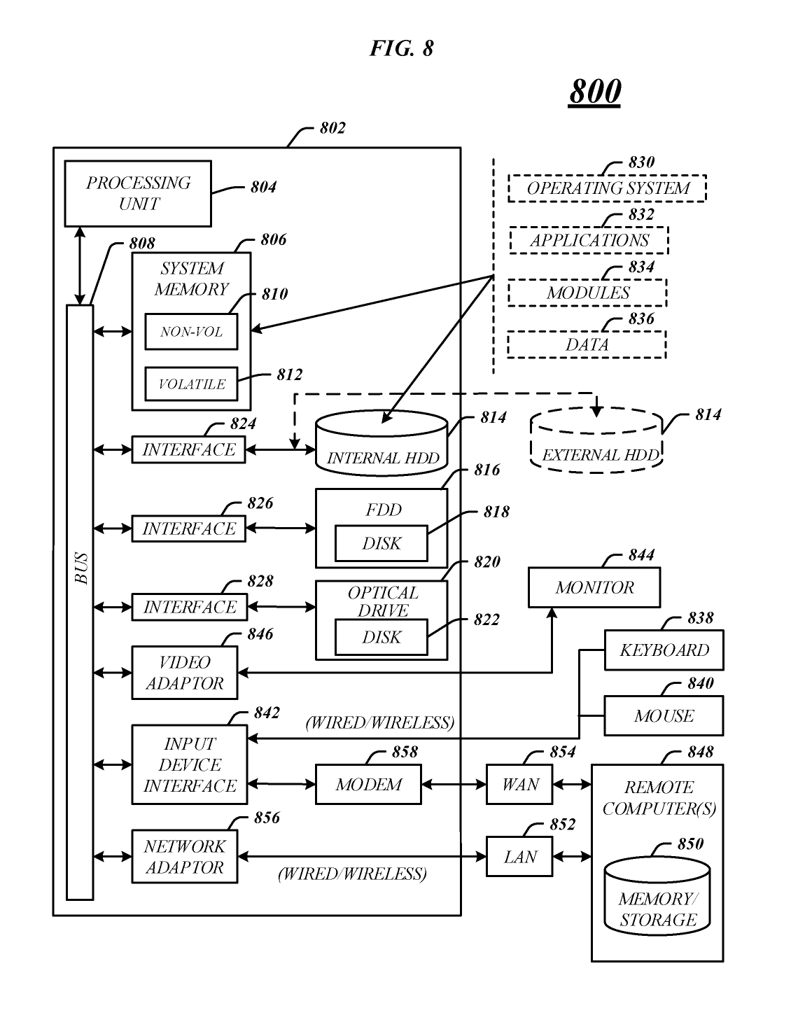

FIG. 8 illustrates an embodiment of an exemplary computing architecture 800 that may be suitable for implementing various embodiments as previously described. In various embodiments, the computing architecture 800 may comprise or be implemented as part of an electronic device. In some embodiments, the computing architecture 800 may be representative, for example, of a computer system that implements or utilizes one or more components of operating environment 100 of FIG. 1, operating environment 200 of FIG. 2A, and/or operating environment 250 of FIG. 2B. In some embodiments, computing architecture 800 may be representative, for example, of one or more portions of IOMMU 104 or CPU 108 that implement or utilize one or more embodiments described herein. For instance, IOMMU 104 may be a GPU operating in conjunction with computing architecture 800. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. In some embodiments, system memory 806 may include main memory. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and Institute of Electrical and Electronics Engineers (IEEE) 994 interface technologies. In various embodiments, these types of memory may not be included in main memory or system memory.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of IOMMU 104, such as one or more portions of request manager 202 and/or page manager 204.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 994 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. In various embodiments, one or more migrations may occur via the networked environment. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 1358, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

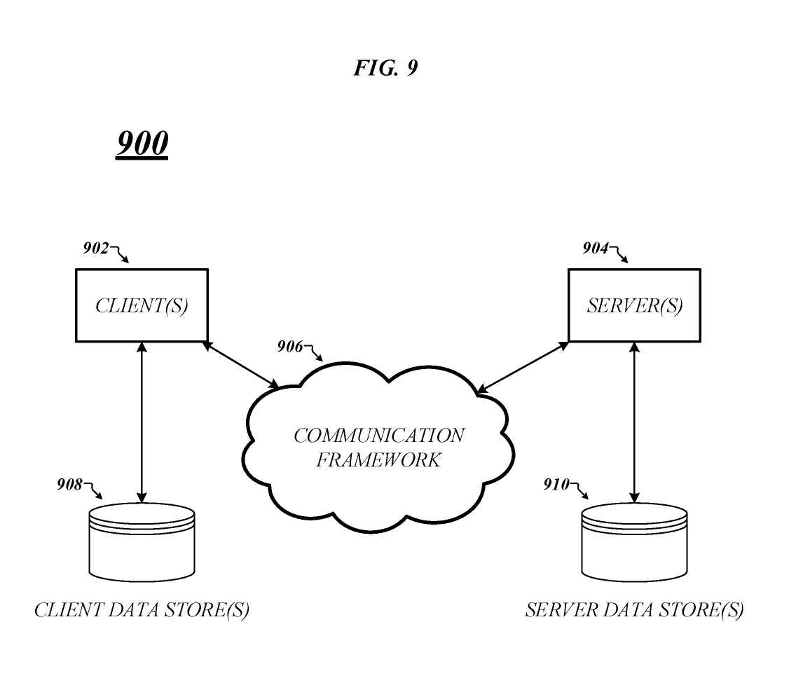

FIG. 9 illustrates a block diagram of an exemplary communications architecture 900 suitable for implementing various embodiments as previously described, such as virtual machine migration. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 comprises includes one or more clients 902 and servers 904. The clients 902 and the servers 904 are operatively connected to one or more respective client data stores 908 and server data stores 910 that can be employed to store information local to the respective clients 902 and servers 904, such as cookies and/or associated contextual information. In various embodiments, any one of servers 904 may implement one or more of logic flows or operations described herein, and storage medium 700 of FIG. 7 in conjunction with storage of data received from any one of clients 902 on any of server data stores 910. In one or more embodiments, one or more of client data store(s) 908 or server data store(s) 910 may include SVM 106.

The clients 902 and the servers 904 may communicate information between each other using a communication framework 906. The communications framework 906 may implement any well-known communications techniques and protocols. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 902 and the servers 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is an apparatus for control flow protection, the apparatus comprising: a memory; and logic for an input/output memory management unit (IOMMU), at least a portion of the logic implemented in circuitry coupled to the memory, the logic to: receive a memory access request from a shared virtual memory (SVM) device, the memory access request comprising a type of a plurality of types of memory access requests; identify a translation entry associated with the memory access request in a cache, the translation entry comprising a permission set; perform the memory access request when the permission set allows the type of the memory access request; and generate an access request fault when the permission set restricts the type of the memory access request.

Example 2 includes the subject matter of Example 1, each permission in the permission set to allow or restrict a type of the plurality of types of memory access requests.

Example 3 includes the subject matter of Example 1, the set of permissions comprising one or more of a read permission, a write permission, and an execute permission.

Example 4 includes the subject matter of Example 1, the IOMMU comprising the cache.

Example 5 includes the subject matter of Example 1, the cache comprising a translation lookaside buffer (TLB).

Example 6 includes the subject matter of Example 1, the translation entry comprising a set of bits and each permission in the permission set comprising a subset of the set of bits.

Example 7 includes the subject matter of Example 1, comprising one or more registers, contents of the one or more registers to activate the logic.

Example 8 includes the subject matter of Example 1, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 9 includes the subject matter of Example 1, the memory access request comprising a virtual address.

Example 10 includes the subject matter of Example 9, the logic to identify the translation entry associated with the memory access request in the cache based on the virtual address.

Example 11 includes the subject matter of Example 9, the logic to determine a linear address that corresponds to the virtual address based on the translation entry.

Example 12 includes the subject matter of Example 1, the logic to signal an exception handler of the access request fault when the permission set restricts the type of the memory access request.

Example 13 includes the subject matter of Example 12, the exception handler comprised in an operating system (OS), the exception handler to terminate the memory access request.

Example 14 is an apparatus for control flow protection, the apparatus comprising: a memory; and logic for an input/output memory management unit (IOMMU), at least a portion of the logic implemented in circuitry coupled to the memory, the logic to: receive a memory transaction request from a shared virtual memory (SVM) device, the memory transaction request comprising an address associated with a memory page in an SVM utilized by the SVM device; determine the memory transaction request includes a translation request and is associated with a write request; identify whether the memory page associated with the memory transaction request is executable; generate a translation completion with read and write access when the memory page associated with the memory transaction request is not executable; and generate a translation completion with read-only access when the memory page associated with the memory transaction request is executable.

Example 15 includes the subject matter of Example 14, the logic to send the translation completion with read and write access to the SVM device when the memory page associated with the memory transaction request is not executable.

Example 16 includes the subject matter of Example 14, the logic to send the translation completion with read-only access to the SVM device when the memory page associated with the memory transaction request is executable.

Example 17 includes the subject matter of Example 14, the IOMMU comprising an IOMMU cache with at least one translation entry associated with a previous memory transaction between the IOMMU and the SVM device.

Example 18 includes the subject matter of Example 17, the logic to identify whether the memory page associated with the memory transaction request is executable based on the IOMMU cache.

Example 19 includes the subject matter of Example 14, the logic to identify whether the memory page associated with the memory transaction request is executable based on one or more page table walks.

Example 20 includes the subject matter of Example 14, comprising the SVM device, the SVM device comprising a device cache with at least one translation entry associated with a previous memory transaction between the IOMMU and the SVM device.

Example 21 includes the subject matter of Example 14, the memory transaction request comprising an address type field to indicate whether the address associated with the memory page in the SVM is translated or untranslated.

Example 22 includes the subject matter of Example 21, the memory transaction request comprising a header that includes the address type field.

Example 23 includes the subject matter of Example 14, comprising one or more registers, contents of the one or more registers to activate the logic.

Example 24 includes the subject matter of Example 14, comprising a central processing unit (CPU), the CPU and the SVM device to utilize the SVM.

Example 25 includes the subject matter of Example 14, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 26 is at least one non-transitory computer-readable medium comprising a set of instructions that, in response to being executed by a processor circuit, cause the processor circuit to: receive a memory access request from a shared virtual memory (SVM) device at an input/output memory management unit (IOMMU), the memory access request comprising a type of a plurality of types of memory access requests; identify a translation entry associated with the memory access request in a cache, the translation entry comprising a permission set; perform the memory access request when the permission set allows the type of the memory access request; and generate an access request fault when the permission set restricts the type of the memory access request.

Example 27 includes the subject matter of Example 26, each permission in the permission set to allow or restrict a type of the plurality of types of memory access requests.

Example 28 includes the subject matter of Example 26, the set of permissions comprising one or more of a read permission, a write permission, and an execute permission.

Example 29 includes the subject matter of Example 26, the IOMMU comprising the cache.

Example 30 includes the subject matter of Example 26, the cache comprising a translation lookaside buffer (TLB).

Example 31 includes the subject matter of Example 26, the translation entry comprising a set of bits and each permission in the permission set comprising a subset of the set of bits.

Example 32 includes the subject matter of Example 26, comprising one or more registers, contents of the one or more registers to activate the logic.

Example 33 includes the subject matter of Example 26, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 34 includes the subject matter of Example 26, the memory access request comprising a virtual address.

Example 35 includes the subject matter of Example 34, comprising instructions that, in response to being executed by the processor circuit, cause the processor circuit to identify the translation entry associated with the memory access request in the cache based on the virtual address.

Example 36 includes the subject matter of Example 34, comprising instructions that, in response to being executed by the processor circuit, cause the processor circuit to determine a linear address that corresponds to the virtual address based on the translation entry.

Example 37 includes the subject matter of Example 26, comprising instructions that, in response to being executed by the processor circuit, cause the processor circuit to signal an exception handler of the access request fault when the permission set restricts the type of the memory access request.

Example 38 includes the subject matter of Example 37, the exception handler comprised in an operating system (OS), the exception handler to terminate the memory access request.

Example 39 is at least one non-transitory computer-readable medium comprising a set of instructions that, in response to being executed by a processor circuit, cause the processor circuit to: receive a memory transaction request from a shared virtual memory (SVM) device at an input/output memory management unit (IOMMU), the memory transaction request comprising an address associated with a memory page in an SVM utilized by the SVM device; determine the memory transaction request includes a translation request and is associated with a write request; identify whether the memory page associated with the memory transaction request is executable; generate a translation completion with read and write access when the memory page associated with the memory transaction request is not executable; and generate a translation completion with read-only access when the memory page associated with the memory transaction request is executable.

Example 40 includes the subject matter of Example 39, comprising instructions that, in response to being executed by the processor circuit, cause the processor circuit to send the translation completion with read and write access to the SVM device when the memory page associated with the memory transaction request is not executable.

Example 41 includes the subject matter of Example 39, comprising instructions that, in response to being executed by the processor circuit, cause the processor circuit to send the translation completion with read-only access to the SVM device when the memory page associated with the memory transaction request is executable.

Example 42 includes the subject matter of Example 39, the IOMMU comprising an IOMMU cache with at least one translation entry associated with a previous memory transaction between the IOMMU and the SVM device.

Example 43 includes the subject matter of Example 42, comprising instructions that, in response to being executed by the processor circuit, cause the processor circuit to identify whether the memory page associated with the memory transaction request is executable based on the IOMMU cache.

Example 44 includes the subject matter of Example 39, comprising instructions that, in response to being executed by the processor circuit, cause the processor circuit to identify whether the memory page associated with the memory transaction request is executable based on one or more page table walks.

Example 45 includes the subject matter of Example 39, comprising the SVM device, the SVM device comprising a device cache with at least one translation entry associated with a previous memory transaction between the IOMMU and the SVM device.

Example 46 includes the subject matter of Example 39, the memory transaction request comprising an address type field to indicate whether the address associated with the memory page in the SVM is translated or untranslated.

Example 47 includes the subject matter of Example 46, the memory transaction request comprising a header that includes the address type field.

Example 48 includes the subject matter of Example 39, comprising one or more registers, contents of the one or more registers to activate the logic.

Example 49 includes the subject matter of Example 39, comprising a central processing unit (CPU), the CPU and the SVM device to utilize the SVM.

Example 50 includes the subject matter of Example 39, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 51 is a computer-implemented method, comprising: receiving a memory access request from a shared virtual memory (SVM) device at an input/output memory management unit (IOMMU), the memory access request comprising a type of a plurality of types of memory access requests; identifying a translation entry associated with the memory access request in a cache, the translation entry comprising a permission set; performing the memory access request when the permission set allows the type of the memory access request; and generating an access request fault when the permission set restricts the type of the memory access request.

Example 52 includes the subject matter of Example 51, each permission in the permission set to allow or restrict a type of the plurality of types of memory access requests.

Example 53 includes the subject matter of Example 51, the set of permissions comprising one or more of a read permission, a write permission, and an execute permission.

Example 54 includes the subject matter of Example 51, the IOMMU comprising the cache.

Example 55 includes the subject matter of Example 51, the cache comprising a translation lookaside buffer (TLB).

Example 56 includes the subject matter of Example 51, the translation entry comprising a set of bits and each permission in the permission set comprising a subset of the set of bits.

Example 57 includes the subject matter of Example 51, comprising one or more registers, contents of the one or more registers to activate the logic.

Example 58 includes the subject matter of Example 51, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 59 includes the subject matter of Example 51, the memory access request comprising a virtual address.

Example 60 includes the subject matter of Example 59, comprising identifying the translation entry associated with the memory access request in the cache based on the virtual address.

Example 61 includes the subject matter of Example 59, comprising determining a linear address that corresponds to the virtual address based on the translation entry.

Example 62 includes the subject matter of Example 51, comprising signaling an exception handler of the access request fault when the permission set restricts the type of the memory access request.

Example 63 includes the subject matter of Example 62, the exception handler comprised in an operating system (OS), the exception handler to terminate the memory access request.

Example 64 is a computer-implemented method, comprising: receiving a memory transaction request from a shared virtual memory (SVM) device at an input/output memory management unit (IOMMU), the memory transaction request comprising an address associated with a memory page in an SVM utilized by the SVM device; determining the memory transaction request includes a translation request and is associated with a write request; identifying whether the memory page associated with the memory transaction request is executable; generating a translation completion with read and write access when the memory page associated with the memory transaction request is not executable; and generating a translation completion with read-only access when the memory page associated with the memory transaction request is executable.

Example 65 includes the subject matter of Example 64, comprising sending the translation completion with read and write access to the SVM device when the memory page associated with the memory transaction request is not executable.

Example 66 includes the subject matter of Example 64, comprising sending the translation completion with read-only access to the SVM device when the memory page associated with the memory transaction request is executable.

Example 67 includes the subject matter of Example 64, the IOMMU comprising an IOMMU cache with at least one translation entry associated with a previous memory transaction between the IOMMU and the SVM device.

Example 68 includes the subject matter of Example 67, comprising identifying whether the memory page associated with the memory transaction request is executable based on the IOMMU cache.

Example 69 includes the subject matter of Example 64, comprising identifying whether the memory page associated with the memory transaction request is executable based on one or more page table walks.

Example 70 includes the subject matter of Example 64, comprising the SVM device, the SVM device comprising a device cache with at least one translation entry associated with a previous memory transaction between the IOMMU and the SVM device.

Example 71 includes the subject matter of Example 64, the memory transaction request comprising an address type field to indicate whether the address associated with the memory page in the SVM is translated or untranslated.

Example 72 includes the subject matter of Example 71, the memory transaction request comprising a header that includes the address type field.

Example 73 includes the subject matter of Example 64, comprising one or more registers, contents of the one or more registers to activate the logic.

Example 74 includes the subject matter of Example 64, comprising a central processing unit (CPU), the CPU and the SVM device to utilize the SVM.

Example 75 includes the subject matter of Example 64, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 76 is an apparatus for control flow protection, the apparatus comprising: means for receiving a memory access request from a shared virtual memory (SVM) device at an input/output memory management unit (IOMMU), the memory access request comprising a type of a plurality of types of memory access requests; means for identifying a translation entry associated with the memory access request in a cache, the translation entry comprising a permission set; means for performing the memory access request when the permission set allows the type of the memory access request; and means for generating an access request fault when the permission set restricts the type of the memory access request.

Example 77 includes the subject matter of Example 76, each permission in the permission set to allow or restrict a type of the plurality of types of memory access requests.

Example 78 includes the subject matter of Example 76, the set of permissions comprising one or more of a read permission, a write permission, and an execute permission.

Example 79 includes the subject matter of Example 76, the IOMMU comprising the cache.

Example 80 includes the subject matter of Example 76, the cache comprising a translation lookaside buffer (TLB).

Example 81 includes the subject matter of Example 76, the translation entry comprising a set of bits and each permission in the permission set comprising a subset of the set of bits.

Example 82 includes the subject matter of Example 76, comprising one or more registers, contents of the one or more registers to activate the logic.

Example 83 includes the subject matter of Example 76, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 84 includes the subject matter of Example 76, the memory access request comprising a virtual address.

Example 85 includes the subject matter of Example 84, comprising means for identifying the translation entry associated with the memory access request in the cache based on the virtual address.

Example 86 includes the subject matter of Example 84, comprising means for determining a linear address that corresponds to the virtual address based on the translation entry.

Example 87 includes the subject matter of Example 76, comprising means for signaling an exception handler of the access request fault when the permission set restricts the type of the memory access request.

Example 88 includes the subject matter of Example 87, the exception handler comprised in an operating system (OS), the exception handler to terminate the memory access request.

Example 89 is an apparatus for control flow protection, the apparatus comprising: means for receiving a memory transaction request from a shared virtual memory (SVM) device at an input/output memory management unit (IOMMU), the memory transaction request comprising an address associated with a memory page in an SVM utilized by the SVM device; means for determining the memory transaction request includes a translation request and is associated with a write request; means for identifying whether the memory page associated with the memory transaction request is executable; means for generating a translation completion with read and write access when the memory page associated with the memory transaction request is not executable; and means for generating a translation completion with read-only access when the memory page associated with the memory transaction request is executable.

Example 90 includes the subject matter of Example 89, comprising means for sending the translation completion with read and write access to the SVM device when the memory page associated with the memory transaction request is not executable.

Example 91 includes the subject matter of Example 89, comprising means for sending the translation completion with read-only access to the SVM device when the memory page associated with the memory transaction request is executable.

Example 92 includes the subject matter of Example 89, the IOMMU comprising an IOMMU cache with at least one translation entry associated with a previous memory transaction between the IOMMU and the SVM device.

Example 93 includes the subject matter of Example 92, comprising means for identifying whether the memory page associated with the memory transaction request is executable based on the IOMMU cache.

Example 94 includes the subject matter of Example 89, comprising means for identifying whether the memory page associated with the memory transaction request is executable based on one or more page table walks.

Example 95 includes the subject matter of Example 89, comprising the SVM device, the SVM device comprising a device cache with at least one translation entry associated with a previous memory transaction between the IOMMU and the SVM device.

Example 96 includes the subject matter of Example 89, the memory transaction request comprising an address type field to indicate whether the address associated with the memory page in the SVM is translated or untranslated.

Example 97 includes the subject matter of Example 96, the memory transaction request comprising a header that includes the address type field.

Example 98 includes the subject matter of Example 89, comprising one or more registers, contents of the one or more registers to activate the logic.

Example 99 includes the subject matter of Example 89, comprising a central processing unit (CPU), the CPU and the SVM device to utilize the SVM.

Example 100 includes the subject matter of Example 89, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. An apparatus for control flow protection, the apparatus comprising:
a memory; and
logic for an input/output memory management unit (IOMMU), at least a portion of the logic implemented in circuitry coupled to the memory, the logic to:
receive a memory access request from a shared virtual memory (SVM) device, the memory access request comprising a type of a plurality of types of memory access requests;
identify a translation entry associated with the memory access request in a cache, the translation entry comprising a permission set;
perform the memory access request when the permission set allows the type of the memory access request; and
generate an access request fault when the permission set restricts the type of the memory access request.

2. The apparatus of claim 1, each permission in the permission set to allow or restrict a type of the plurality of types of memory access requests.

3. The apparatus of claim 1, the set of permissions comprising one or more of a read permission, a write permission, and an execute permission.

4. The apparatus of claim 1, the IOMMU comprising the cache.

5. The apparatus of claim 1, the cache comprising a translation lookaside buffer (TLB).

6. The apparatus of claim 1, the translation entry comprising a set of bits and each permission in the permission set comprising a subset of the set of bits.

7. The apparatus of claim 1, comprising one or more registers, contents of the one or more registers to activate the logic.

8. The apparatus of claim 1, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

9. The apparatus of claim 1, the memory access request comprising a virtual address.

10. The apparatus of claim 9, the logic to identify the translation entry associated with the memory access request in the cache based on the virtual address.

11. The apparatus of claim 1, the logic to signal an exception handler of the access request fault when the permission set restricts the type of the memory access request.

12. The apparatus of claim 11, the exception handler comprised in an operating system (OS), the exception handler to terminate the memory access request.

13. At least one non-transitory computer-readable medium comprising a set of instructions that, in response to being executed by a processor circuit, cause the processor circuit to:
receive a memory transaction request from a shared virtual memory (SVM) device at an input/output memory management unit (IOMMU), the memory transaction request comprising an address associated with a memory page in an SVM utilized by the SVM device;
determine the memory transaction request includes a translation request and is associated with a write request;
identify whether the memory page associated with the memory transaction request is executable;
generate a translation completion with read and write access when the memory page associated with the memory transaction request is not executable; and
generate a translation completion with read-only access when the memory page associated with the memory transaction request is executable.

14. The at least one non-transitory computer-readable medium of claim 13, the IOMMU comprising an IOMMU cache with at least one translation entry associated with a previous memory transaction between the IOMMU and the SVM device.

15. The at least one non-transitory computer-readable medium of claim 16, comprising instructions that, in response to being executed by the processor circuit, cause the processor circuit to identify whether the memory page associated with the memory transaction request is executable based on the IOMMU cache.

16. The at least one non-transitory computer-readable medium of claim 13, comprising instructions that, in response to being executed by the processor circuit, cause the processor circuit to identify whether the memory page associated with the memory transaction request is executable based on one or more page table walks.

17. The at least one non-transitory computer-readable medium of claim 13, comprising the SVM device, the SVM device comprising a device cache with at least one translation entry associated with a previous memory transaction between the IOMMU and the SVM device.

18. The at least one non-transitory computer-readable medium of claim 13, the memory transaction request comprising an address type field to indicate whether the address associated with the memory page in the SVM is translated or untranslated.

19. The at least one non-transitory computer-readable medium of claim 18, the memory transaction request comprising a header that includes the address type field.

20. The at least one non-transitory computer-readable medium of claim 13, comprising one or more registers, contents of the one or more registers to activate the logic.

21. The at least one non-transitory computer-readable medium of claim 13, comprising a central processing unit (CPU), the CPU and the SVM device to utilize the SVM.

22. The at least one non-transitory computer-readable medium of claim 13, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

23. A computer-implemented method, comprising:
receiving a memory transaction request from a shared virtual memory (SVM) device at an input/output memory management unit (IOMMU), the memory transaction request comprising an address associated with a memory page in an SVM utilized by the SVM device;
determining the memory transaction request includes a translation request and is associated with a write request;
identifying whether the memory page associated with the memory transaction request is executable;
generating a translation completion with read and write access when the memory page associated with the memory transaction request is not executable; and
generating a translation completion with read-only access when the memory page associated with the memory transaction request is executable.

24. The computer-implemented method of claim 23, comprising sending the translation completion with read and write access to the SVM device when the memory page associated with the memory transaction request is not executable.

25. The computer-implemented method of claim 23, comprising sending the translation completion with read-only access to the SVM device when the memory page associated with the memory transaction request is executable.
